(19) United States
(12) Patent Application Publication
(10) Pub. No.: US 2026/0042201 A1
(43) Pub. Date: Feb. 12, 2026

(54) VARIABLE STIFFNESS MECHANISM

(71) Applicant: The Board of Regents of University of Nebraska, Lincoln, NE (US)

(72) Inventors: Carl Nelson, Lincoln, NE (US); Nick Swerczek, Omaha, NE (US)

(21) Appl. No.: 19/294,485

(22) Filed: Aug. 8, 2025

Related U.S. Application Data
(60) Provisional application No. 63/680,689, filed on Aug. 8, 2024.

(51) Int. Cl. B25J 9/00; B25J 9/10; B25J 19/00

(52) U.S. Cl. CPC B25J 9/0009; B25J 9/0087; B25J 9/106; B25J 19/0004

(57) ABSTRACT

A variable stiffness mechanism for robotic applications. A robotic arm segment comprising two bodies pivotably coupled together at one end and having a generally elongate form factor. A spring-loaded carriage moves longitudinally along one of the two bodies and is in contact with the other body, such that the effective rotational stiffness of the pin joint is equal to the stiffness of the carriage spring multiplied by the distance between the pin joint and the spring. The distance between the pin joint and the spring can be varied using a motor and belt drive arrangement. A stopper may be coupled to the belt drive to lock the relative motion of the two bodies.

### RELATED APPLICATIONS

This application claims priority to U.S. Provisional Patent Application No. 63/680,689, filed Aug. 8, 2024, the entire contents of which are incorporated herein by reference.

### TECHNICAL FIELD

The various embodiments herein relate to mechanical links and/or joints, and more particularly to a variable-stiffness link that behaves like a variable-stiffness joint and which may have applicability in certain robotic applications.

### BACKGROUND

Variable-stiffness mechanisms have become a topic of research interest in the past two decades, with potential applications in human-safe interactions and payload handling among others. Although a device's apparent stiffness can be varied in a variety of ways, including through variable damping, software implementation of controls, and variation of inertia, endowing mechanisms with inherent mechanical compliance along with the ability to vary that property is an approach that has been widely pursued.

Mechanical stiffness variation can take on a number of forms. Approaches for adjustable joints or actuators include series-elastic arrangements, various types of antagonistic springs, adjustment of spring preload, and variable levers.

A number of designs have been proposed to apply the variable-lever concept to robotic stiffness variation, with the advantage that in general the work required to vary stiffness is small since the load carried in the joint can be kept orthogonal to the stiffness-variation motion. Most of these devices fall into the category of variable-stiffness actuators (i.e., a variable-stiffness mechanism integrated with an actuator), and the challenge in these cases is to make the actuator package as compact as possible. The design tradeoff tends to be the need for enough lever length to have a meaningful stiffness adjustment range. Another approach is the design of variable-stiffness links (as opposed to variable-stiffness actuators). In this approach, the stiffness variation occurs in the link properties instead of being lumped in the actuator. Examples of this include changing orientation or constraint conditions of a beam functioning as the robotic link.

There remains a need in the art for improvements in the area of variable-stiffness links.

### SUMMARY

Discussed herein is a variable stiffness link mechanism for robotic interactions and applications. The operating principle is based on an actively changing lever arm. The robotic arm segment is composed of two bodies coupled together (e.g., pinned, or pivotably coupled to each other via a pin joint, for example) at one end and having a generally straight and/or elongated form factor with one body “surrounding” the other on two opposite (long) sides, according to some embodiments. A spring-loaded carriage rides on one body and contacts the other, such that the effective rotational stiffness of the pin joint is equal to the stiffness of the carriage spring times the (variable) distance between the pin joint and the carriage. If a belt is used to drive the carriage along the arm segment, a stopper attached to the belt on the opposite side of the carriage attachment can be used to stop or lock the relative motion of the two bodies when the carriage reaches its extreme (highest stiffness) position. Because the force acting through the spring is perpendicular to the travel direction of the spring carriage, the stiffness adjustment is decoupled from a rotational load carried through the link, allowing the stiffness-adjusting motor to be very small. The overall assembly is relatively simple and can be constructed largely by using modular off-the-shelf components, making it inexpensive.

In some embodiments, a first link has a first elongate arm that does not necessarily “surround” a second elongate arm of a second link. For example, the first and second elongate arms could be arranged in a generally side-by-side configuration, with a pivotable coupling (e.g., a pin joint or pivot joint) coupling the first and second arms to each other at or near one end (e.g., a proximal end) of one of the elongate arms. In such an embodiment, a spring may be slidably and/or translationally coupled (e.g., via a carriage in some embodiments) to one of the first and second elongate arms such that the spring rides along one arm and is in contact with the other arm such that a spring force (e.g., determined by an amount of compression or tension of the spring and/or other material properties) is exerted between the first and second arms at a distance from the pin joint that can be varied. In such embodiments, the effective rotational stiffness of the pin joint is equal to the stiffness of the spring multiplied by the (variable) distance between the pin joint and the spring.

In some embodiments, a variable stiffness mechanism for robotic applications can include an outer link, an inner link, and a carriage. In this embodiment, the outer link can comprise two elongate arms extending distally from a proximal portion, at least one of the two elongate arms being mechanically compliant. The inner link can have a proximal end and a distal end, the proximal end being pivotably coupled to the proximal portion of the outer link at a pivot joint. An elongate portion of the inner link can be operably suspended between the two elongate arms of the outer link. The carriage can be coupled to the inner link and is configured to be in contact with at least the mechanically compliant elongate arm. The carriage is configured to move along a length of the inner link to change a position of the carriage relative to the pivot joint. In such embodiments of a variable stiffness mechanism, changing the position of the carriage relative to the pivot joint can change the stiffness of the variable stiffness mechanism. Alternatively, the variable stiffness mechanism could include a first link, a second link, and a carriage. In this embodiment, the first link can comprise a first elongate arm extending distally from a proximal portion, the elongate arm being mechanically compliant. The second link can comprise a second elongate arm having a proximal end and a distal end, the proximal end being pivotably coupled to the proximal portion of the first link at a pivot joint. The carriage can be coupled to the second elongate arm, the carriage being configured to be in contact with the mechanically compliant first elongate arm. The carriage is configured to move along a length of the second elongate arm to change the position of the carriage relative to the pivot joint. In such embodiments of a variable stiffness mechanism, changing the position of the carriage relative to the pivot joint can change the stiffness of the variable stiffness mechanism.

The ability to vary the stiffness of a robotic arm, for example, may provide a desired amount or degree of compliance to the actuation of the robotic arm that can be beneficial in ensuring safe interactions between robotic systems and humans (e.g., human-safe interactions), or in preventing damage in certain payload handling applications, for example.

While multiple embodiments are disclosed, still other embodiments will become apparent to those skilled in the art from the following detailed description, which shows and describes illustrative embodiments. As will be realized, the various implementations are capable of modifications in various obvious aspects, all without departing from the spirit and scope thereof. Accordingly, the drawings and detailed description are to be regarded as illustrative in nature and not restrictive.

### BRIEF DESCRIPTION OF DRAWINGS

FIG. 1A is a schematic representation of a variable-stiffness link, according to an embodiment of this disclosure;

FIG. 1B is a plot representing small-angled spring deflection, according to various embodiments of this disclosure;

FIG. 1C is a schematic representation of a variable-stiffness link, according to an embodiment of this disclosure;

FIG. 2A is an overhead image of a prototype of a variable-stiffness link, according to various embodiments of this disclosure;

FIG. 2B is an enlarged image of a prototype of a variable-stiffness link showing details of a spring and first carriage arrangement, according to various embodiments of this disclosure;

FIG. 2C is an enlarged image of a prototype of a variable-stiffness link showing details of a second carriage with a stopper or locking member coupled thereto, according to various embodiments of this disclosure;

FIG. 3 is a graphical plot of torque vs. deflection angles for a variable-stiffness link, with a series of plots corresponding to a number of different spring-carriage positions, according to various embodiments of this disclosure;

FIG. 4 is a graphical plot of rotational stiffness as a function of spring-carriage position for a variable-stiffness link, according to various embodiments of this disclosure;

FIG. 5 is a plot of compliance ellipses for various positions of an end effector (when k1=1 and k2=1) for a variable-stiffness link, according to various embodiments of this disclosure;

FIG. 6 is a plot of compliance ellipses for various positions of an end effector (when k1=4 and k2=1) for a variable-stiffness link, according to various embodiments of this disclosure;

FIG. 7 is a plot of compliance ellipses for various positions of an end effector (when k1=7 and k2=1) for a variable-stiffness link, according to various embodiments of this disclosure;

FIG. 8 is a plot of compliance ellipses for various positions of an end effector (when k1=10 and k2=1) for a variable-stiffness link, according to various embodiments of this disclosure;

FIG. 9 is a plot of compliance ellipses for various positions of an end effector (when k1=1 and k2=4) for a variable-stiffness link, according to various embodiments of this disclosure;

FIG. 10 is a plot of compliance ellipses for various positions of an end effector (when k1=1 and k2=7) for a variable-stiffness link, according to various embodiments of this disclosure; and

FIG. 11 is a plot of compliance ellipses for various positions of an end effector (when k1=1 and k2=10) for a variable-stiffness link, according to various embodiments of this disclosure.

### DETAILED DESCRIPTION

The various embodiments described herein relate to systems, devices, and/or methods for a variable stiffness mechanism for robotic rotational degrees of freedom. The operating principle is based on an actively changing lever arm. The robotic arm segment can comprise two bodies pivotably coupled or “pinned” together at one end, each of the two bodies having a generally straight/elongated form factor with one body “surrounding” the other body on two opposite (long) sides, according to some embodiments of this disclosure. A spring can ride on one body (e.g., via a carriage that is configured to translate along a length of the body or arm) and contacts the other body, such that the effective rotational stiffness of the pin joint is equal to the product of the stiffness of the carriage spring and the (variable) distance between the pin joint and the carriage spring. A belt can be used to drive the spring and/or carriage along the body or arm segment. In such an embodiment, a stopper can be operably coupled to the belt (e.g., on the opposite side of the carriage attachment; the stopper can be used to lock the relative motion of the two bodies relative to each other (e.g., to enforce pseudo-infinite stiffness) when the carriage reaches its extreme (or maximum, or highest stiffness) position. Because the force acting through the spring is perpendicular to the travel direction of the spring and/or carriage, the stiffness adjustment is decoupled from rotational load carried through the link, allowing the stiffness-adjusting motor to be very small. The overall assembly can be constructed using relatively inexpensive components and/or equipment.

Embodiments of this disclosure employ a variable-lever concept to accomplish link-stiffness variation, but in a way that produces an effect more similar to a variable-stiffness actuator.

Some embodiments of the proposed design can use the link itself as a lever arm to produce a variable torsional stiffness. In this way, the packaging of the variable-stiffness mechanism can take advantage of the space occupied by the link, whereas the effect produced is that of torsional stiffness located at the joint. In some embodiments, the link consists of an inner member and an outer member pinned together at one end (e.g., pivotably coupled at a pin joint or pivot joint), a stiffness element (e.g., a spring) interposed between the inner and outer members, and a means of displacing the stiffness element relative to the pin joint so as to vary the effective lever arm acting between the stiffness element and the pivot axis of the inner and outer members. This design retains the advantage of other variable-lever designs in terms of the load in the stiffness-adjusting mechanism being decoupled from the load in the primary actuator. In other words, because the load in the stiffness element can be maintained normal (e.g., perpendicular) to the line of motion of the lever-arm adjustment, the force required to adjust stiffness is only that of overcoming a nominal amount of friction and does not depend on the load state of the link itself.

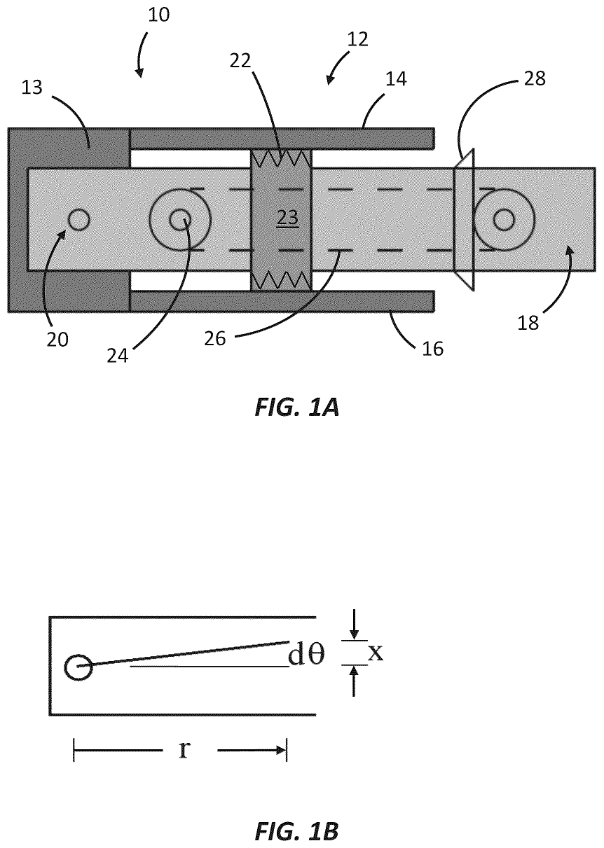

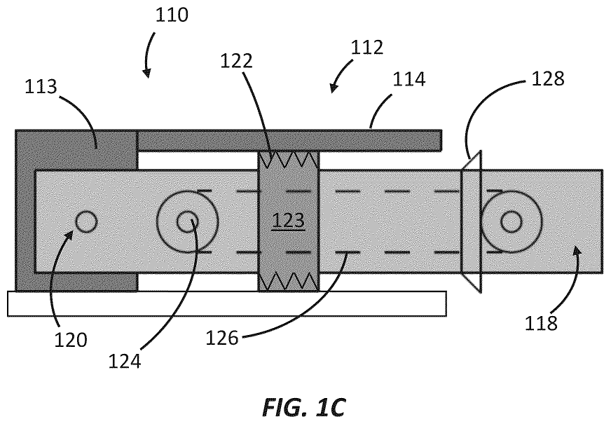

A variable stiffness link according to an embodiment of this disclosure is illustrated schematically in FIG. 1A. For example, FIG. 1A shows a variable stiffness link 10 having an inner link 18 pivotably coupled to an outer link 12 at a pivot joint 20 disposed near a proximal end of the inner link 18 and the outer link 12. In the embodiment depicted, outer link 12 includes two elongate arms 14, 16 extending distally from a proximal portion of outer link. An elongate portion of the inner link 18 can be operably suspended between the elongate arms 14, 16. In some cases, the proximal portion of outer link 12 may include a proximal member 13, as shown in FIG. 1A, which can be arranged for pivotably coupling the outer link 12 to the inner link 18.

FIG. 1A also shows a stiffness or spring element 22 operably coupled to inner link 18 and configured to be moved longitudinally (e.g., re-positioned along a length of inner link 18) via a belt drive 26, for example. In some embodiments, spring element 22 may be mounted to or operably coupled to a carriage 23 to facilitate positioning of the spring element 22 along the length of inner link 18. As shown, spring element 22 can be disposed between and in operable contact with elongate arms 14 and 16, such that a spring force exists between the inner link 18 and the two elongate arms 14 and 16. In some embodiments, changing the position of the spring element 22 relative to the pivot joint 20 can change the stiffness of the variable stiffness mechanism 10. In some embodiments, the two elongate arms 14, 16 of outer link 12 may be formed and/or shaped to at least partially surround the inner link 18.

A motor 24 can be provided to position the spring element 22 and/or carriage 23 along the length of the inner link 18, for example via the belt drive 26, in some implementations. Alternatively, motor 24 could be configured to position the spring element 22 and/or carriage 23 along the length of the inner link 18 via a lead screw or linear actuator (not shown), according to some implementations as would be appreciated by those of ordinary skill in the art. For example, a carriage 23 can be coupled to spring element 22 and coupled to inner link 18 such that the carriage 23 can move along a length of inner link 18 to change the position of spring element 22 relative to the pivot joint 20, according to some embodiments. In some further implementations, a stopper 28 may be coupled (e.g., movably coupled) to the inner link 18 and to the belt drive 26 such that it can be positioned longitudinally along a length of inner link 18 via operation of motor 24 and/or via the belt drive 26. In some implementations, the stopper 28 can be configured to travel from a position distal of the two elongate arms 14, 16 to a position in contact with at least one of the two elongate arms 14, 16. The stopper 28 may have a tapered shape as shown in the embodiment depicted in FIG. 1A; for example, the stopper 28 may provide the capability of “locking” the outer link 12 and inner link 18 such that the stiffness of the joint becomes very large (e.g., nearly infinite stiffness) when the stopper 28 is moved into contact with the outer link 12 (e.g., into contact with the distal ends of elongate arms 14 and 16). In some cases, carriage 23 and/or spring 22 may be coupled to a first portion of belt drive 26, and stopper 28 may be coupled to a second portion of belt drive 26 that is opposite to the first portion such that the stopper 28 moves (in response to actuation of motor 24, for example) in a direction that is opposite of the direction of movement of the spring element 22 and/or the carriage 23. That is, as the “lower” portion of belt drive 26 (as depicted in FIG. 1A) moves from left to right (e.g., moves in a distal direction), the “upper” portion of belt drive 26 moves from right to left (e.g., moves in a proximal direction). In such embodiments, the spring element 22 and/or carriage 23 moves in the opposite direction of stopper 28.

FIG. 1B is a line drawing that illustrates small-angle spring deflection, for example, as it may pertain to the variable stiffness mechanisms of various embodiments of this disclosure. With reference to the embodiment described above with respect to FIG. 1A above, several relationships can be established. For example, the carriage 23 and/or spring 22 can ride (e.g., move or translate) longitudinally along the inner link 18 such that the position of carriage 23 and/or spring 22 can be adjusted using a small motor 24 via a timing-gear belt 26. This movement changes the contact point between the spring 22 (e.g., mounted on the carriage 23) and the outer link 12 to a distance “r” from the axis of rotation (e.g., pivot point 20). Since a linear spring is governed by Eqn. [1], as follows:

F=kx (1)
and assuming relatively small angular displacements between the inner and outer links 18 and 12, the linear spring displacement is provided by Eqn. [2]:

x=r(dθ) (2)
where dθ is the small angular difference between the inner and outer links 18 and 12, with rotation centered at pivot point 20 in FIG. 1A. The associated torque and torsional stiffness are given respectively by Eqns. [3] and [4] as follows:

T=k(dθ) (3)

and

kₜ=kr² (4)
where k is the stiffness of the linear spring element 22 on the carriage 23, and r is the distance from the pivot point 20 to the point of contact between the spring 22 and the links 12, 18 (e.g., the position of carriage 23).

If so desired, the link can be designed such that the carriage travel extends to be coincident with the pivot axis (pivot point 20), leading to a theoretical lower bound of 0 stiffness. The upper bound on stiffness would be provided by Eqn. [5]:

k_{t,max}=krₘₐₓ² (5)

However, if the carriage 23 is driven via belt drive 26 as previously described, a second carriage 28 can travel in the opposite direction along the inner link 18 (e.g., by being attached to a portion of the belt 26 opposite to that of the spring carriage 23) and can function as a stop when it contacts the outer link 12 elements (e.g., elongate arms 14 and 16), providing a “locked” or theoretically infinitely stiff state. The tradeoff is that in this configuration, rₘₐₓ is limited to half the length of inner link 18, and stiffness would change abruptly from k_{t,max} to infinite (within the limits of material stiffness) when the stopper 28 engages in contact with the elongate arms 14 and 16 of the outer link 12.

In some alternative embodiments of this disclosure, a variable-stiffness link 10 can have one or both elongate arms 14, 16 of the outer link 12 function as the stiffness element or spring element (e.g., rather than having a separate spring element 22). For example, one or both elongate arms 14, 16 may be selected or formed to have a certain amount of compliance to thereby act as the spring element. In such embodiments, a carriage 23 can be employed to create or define a varying (e.g., movable) point of contact against the compliant elongate arm 14 and/or 16 (e.g., functioning as a spring-beam). Based on Euler-Bernoulli beam theory, and assuming the base of the beam is aligned with the joint axis, the lateral beam stiffness varies with 1/r³, leading to kₜ proportional to 1/r. In this configuration, the lower bound on stiffness is proportional to the inverse cube of the link length, and the upper bound on stiffness can be high but only approaches infinity as r approaches 0, which is rather poorly defined.

In either case, at any value of equivalent joint stiffness, the joint deflection is limited by the allowed relative motion between the inner and outer link segments.

An alternate version of a variable stiffness link according to an embodiment of this disclosure is illustrated schematically in FIG. 1C. For example, FIG. 1C shows a variable stiffness link 110 having a first link 112 and a second link 118, the second link 118 comprising a second elongate arm 118 pivotably coupled to the first link 112 at a pivot joint 120 disposed near a proximal end of the second link 118 and the first link 112. In the embodiment depicted, the first link 112 includes an elongate arm 114 extending distally from a proximal portion of the first link 112, and the second elongate arm 118 extends from a proximal end to a distal end thereof. In some embodiments, the second elongate arm 118 of the second link 118 can be operably suspended adjacent the first elongate arm 114 of the first link 112 in a generally parallel configuration, as depicted in FIG. 1C. In some cases, the proximal portion of first link 112 may include a proximal member 113, as shown in FIG. 1C, which can be arranged for pivotably coupling the first link 112 to the second link 118.

FIG. 1C also shows a stiffness element or spring element 122 disposed between the first elongate arm 114 and the second elongate arm 118. Spring element 122 can be in operable contact with the first elongate arm 114 and the second elongate arm 118. In some embodiments, spring element 122 can be operably coupled to the second elongate arm 118 and configured to be moved longitudinally (e.g., along a length of second link 118) via a belt drive 126, for example, to change the distance of the spring element 122 from the pivot joint 120.

In some embodiments, variable stiffness mechanism 110 may further include a carriage 123 coupled to the spring 122 and/or to the second link 118. For example, spring element 122 can be mounted to or operably coupled to carriage 123 to facilitate movement or positioning of spring element 122 along the length of second link (or second elongate arm) 118. As shown, spring element 122 can be in contact with elongate arm 114 such that a spring force exists between the second elongate arm 118 and elongate arm 114. In some embodiments, a motor 124 can be provided to facilitate moving or positioning the spring element 122 and/or carriage 123 along the length of the second link 118. In some cases, moving or positioning the spring element 122 and/or carriage 123 along the length of the second link 118 may be accomplished via motor 124 in conjunction with a belt drive 126, as depicted in FIG. 1C. Alternatively, motor 124 could be configured to position the spring element 122 and/or carriage 123 along the length of the second link (or second elongate arm) 118 via a lead screw or a linear actuator (not shown), according to some implementations as would be appreciated by those of ordinary skill in the art.

In some further implementations, a stopper 128 may be coupled to the second elongate arm 118 and to the belt drive 126 such that it can be positioned longitudinally along a length of second elongate arm 118 via operation of motor 124. The stopper 128 may have a tapered shape as shown in the embodiment depicted in FIG. 1C; for example, stopper 128 may provide the capability of “locking” the first link 112 and the second link 118 (or the elongate arms 114 and 118, respectively) such that the stiffness of the joint becomes very large (e.g., nearly infinite stiffness) when the stopper 128 is moved into contact with elongate arm 114 (e.g., into contact with a distal end of elongate arm 114). In some cases, carriage 123 and/or spring 122 may be coupled to a first portion of belt drive 126, and stopper 128 may be coupled to a second portion of belt drive 126 that is opposite to the first portion such that the stopper 128 moves (in response to actuation of motor 124, for example) in a direction that is opposite of the direction of movement of the spring element 122 and/or the carriage 123. That is, as the “lower” portion of belt drive 126 (as depicted in FIG. 1C) moves from left to right (e.g., moves in a distal direction), the “upper” portion of belt drive 126 moves from right to left (e.g., moves in a proximal direction). In such embodiments, the spring element 122 and/or carriage 123 moves in the opposite direction of stopper 128.

### EXAMPLES

### Example 1—Prototype

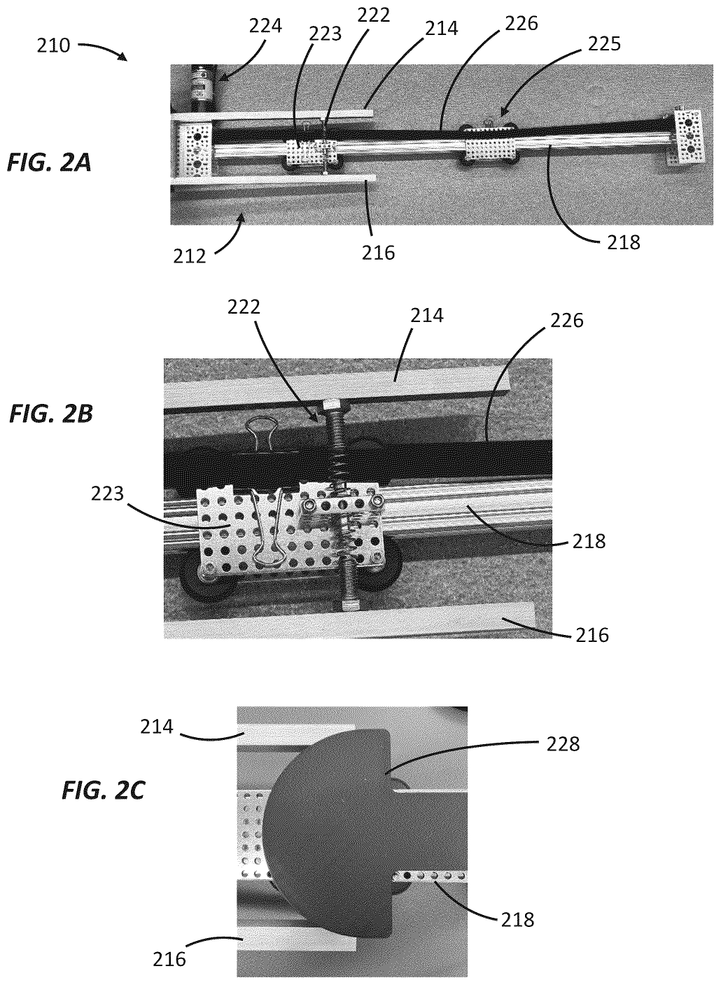

A prototype was constructed to test and/or prove the principle of the proposed design. Inexpensive, modular kit materials were used in order to illustrate the relative case of fabrication. Materials used included items such as extruded aluminum rail, v-rollers, and standard off-the-shelf components such as fasteners and springs. A prototype variable stiffness mechanism 210 and various aspects thereof are depicted in FIGS. 2A-2C, according to some embodiments of this disclosure.

FIG. 2A shows elements of a variable stiffness link 210 as they may be arranged according to some embodiments. For example, variable stiffness link 210 can have an inner link 218 pivotably coupled to an outer link 212 at a pivot joint (not shown in FIG. 2A) disposed near a proximal end of the inner link 218 and the outer link 212 (e.g., a left end, as depicted in FIG. 2A). In the embodiment depicted, outer link 212 includes two elongate arms 214, 216 extending distally from a proximal portion of outer link 212. An elongate portion of the inner link 218 can be operably suspended between the elongate arms 214, 216. In some cases, the proximal portion of outer link 12 may include a proximal member (not shown in FIG. 2A), which can be arranged for pivotably coupling the outer link 212 to the inner link 218. In an alternative embodiment, variable stiffness link 210 need not have a separate proximal member; for example, pivotable coupling between the outer link 212 and the inner link 218 may be provided at a portion of one of the elongate arms 214, 216 shaped and/or configured for this purpose, as would be apparent to one of ordinary skill in the art.

FIG. 2A also shows a stiffness element or spring element 222 operably coupled to inner link 218 and configured to be moved longitudinally (e.g., re-positioned along a length of inner link 218) via a belt drive 226, for example. In some embodiments, spring element 222 may be mounted to or operably coupled to a carriage 223 to facilitate moving or positioning of the spring element 222 along the length of inner link 218. As shown, spring element 222 can be disposed between and in operable contact with elongate arms 214 and 216, such that a spring force is applied between the inner link 218 and the two elongate arms 214 and 216. In some embodiments, changing the position of the spring element 222 relative to the pivot joint can change the stiffness of the variable stiffness mechanism 210. In some embodiments, the two elongate arms 214, 216 of outer link 212 may be formed and/or shaped to at least partially surround the inner link 218.

A motor 224 can be provided to position the spring element 222 and/or carriage 223 along the length of the inner link 218, for example via the belt drive 226, in some implementations. An enlarged view of an exemplary arrangement is provided in FIG. 2B. For example, a carriage 223 can be coupled to spring element 222 and coupled to inner link 218 such that the carriage 223 can move along a length of inner link 218 to change the position of spring element 222 relative to the pivot joint, according to some embodiments. Alternatively, motor 224 could be configured to position the spring element 222 and/or carriage 223 along the length of the inner link 218 via a lead screw or linear actuator (not shown), according to some implementations as would be appreciated by those of ordinary skill in the art.

In some further implementations, a stopper 228 may be coupled (e.g., movably coupled) to the inner link 218 and to the belt drive 226 such that it can be positioned longitudinally along a length of inner link 218 via operation of motor 224 and/or via the belt drive 226. In some implementations, the stopper 228 can be configured to travel from a position distal of the two elongate arms 214, 216 to a position in contact with at least one of the two elongate arms 214, 216, as shown in the enlarged view of FIG. 2C. The stopper 228 may have a tapered, angled, or curved shape as shown in the embodiment depicted in FIG. 2C. Stopper 228 may provide the capability of “locking” the outer link 212 and inner link 218 relative to one another such that the stiffness of the joint becomes very large (e.g., approaching nearly infinite theoretical stiffness) when the stopper 228 is moved into contact with the outer link 212 (e.g., into contact with one or both of the distal ends of elongate arms 214 and 216, as shown in FIG. 2C). In some cases, carriage 223 and/or spring 222 may be coupled to a first portion of belt drive 226, and stopper 228 may be coupled to a second portion of belt drive 226 that is opposite to the first portion such that the stopper 228 moves (in response to actuation of motor 224, for example) in a direction that is opposite of the direction of movement of the spring element 222 and/or the carriage 223. In such embodiments, the spring element 222 and/or carriage 223 is configured to move in the opposite direction of stopper 228.

### Example 2—Load Displacement Testing

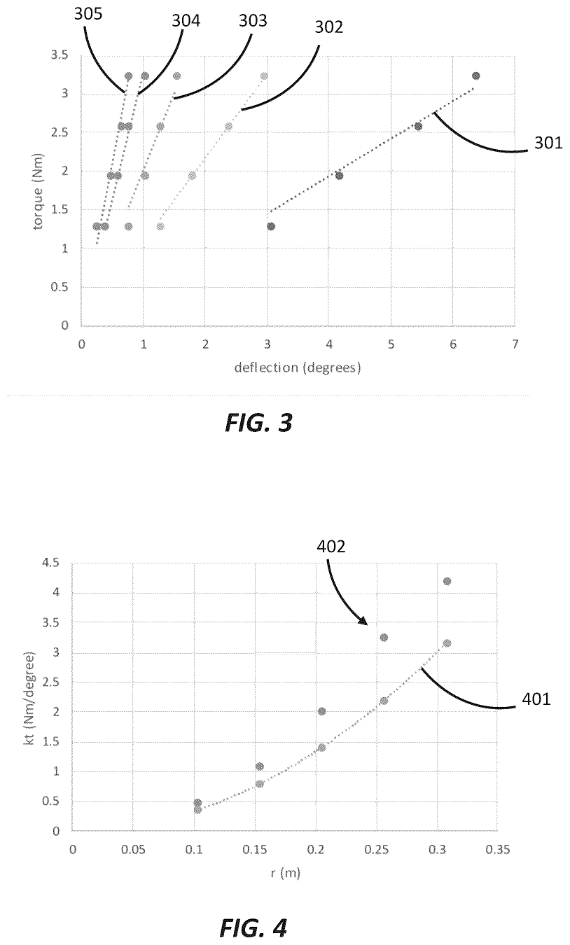

Load-displacement testing was carried out on the prototype to validate the mathematical model in Eqns. [1] through [4] above and to characterize the range and behavior of stiffness variation. The results of such testing are presented in FIGS. 3 and 4.

FIG. 3 is a plot of the torque-deflection relationship for a number of different spring-carriage positions from the pivot joint or pivot axis. For example, segment 301 is a plot of torque (N-m) versus deflection (degrees) for a spring position of approximately 0.1 meters from the pivot axis, segment 302 is a plot of torque versus deflection for a spring position of approximately 0.15 meters from the pivot axis, segment 303 is a plot of torque versus deflection for a spring position of approximately 0.2 meters from the pivot axis, segment 304 is a plot of torque versus deflection for a spring position of approximately 0.25 meters from the pivot axis, and segment 305 is a plot of torque versus deflection for a spring position of approximately 0.3 meters from the pivot axis. FIG. 3 shows that over the range of small angular deflections tested, the use of a linear spring acting approximately normal to the link produced a variation in linear rotational stiffness as a function of the spring position as expected, with the stiffness being related to the slope of the respective torque-deflection curves, as shown.

FIG. 4 is a plot of the rotational stiffness as a function of spring carriage position for the five spring carriage positions tested (as noted above with respect to FIG. 3). For example, the theoretical/mathematical model predicted by Eqn. [4] is shown by segment 401 in FIG. 4; the experimental results are shown plotted in segment 402 in FIG. 4. FIG. 4 indicates that the variation of rotational stiffness (e.g., the slopes of the best-fit lines provided in FIG. 3) with carriage position is in reasonable agreement with the (2nd-order) model predicted by Eqn. [4]. The slight deviation between the experimental results 402 and the theoretical model 401 may be attributable to preload in the system, etc.

### Example 3—Integrating Into Robotic System

To show how this type of variably-stiff link module could be integrated in a useful robotic system, we take the example of a two-link planar robot. For the purposes of illustration, minimum and maximum rotational stiffness values of k_{min,max}={1, 10} Nm/degree, and link lengths of l_{1,2}={2, 1} m were implemented in simulation using MATLAB. The well-known Jacobian of the two-link manipulator was used along with the inverse of the joint stiffness matrix according to

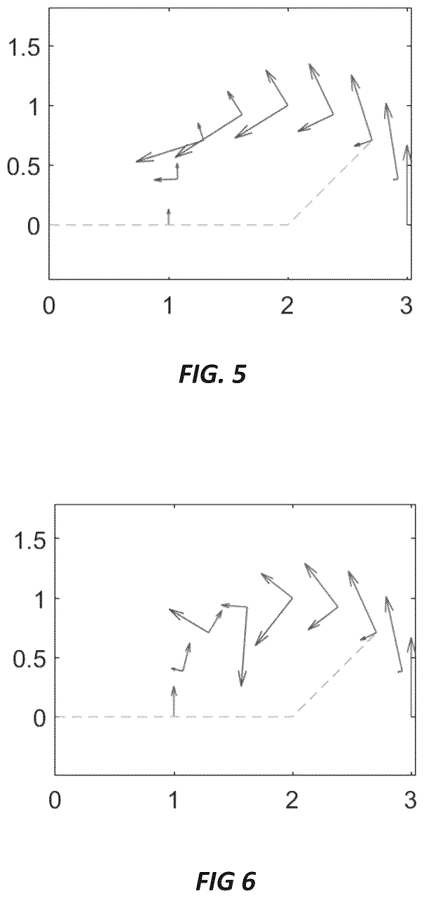

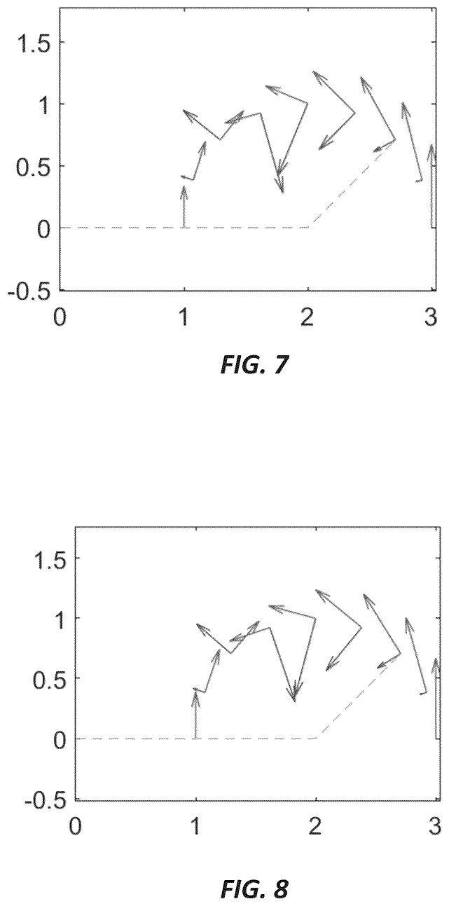

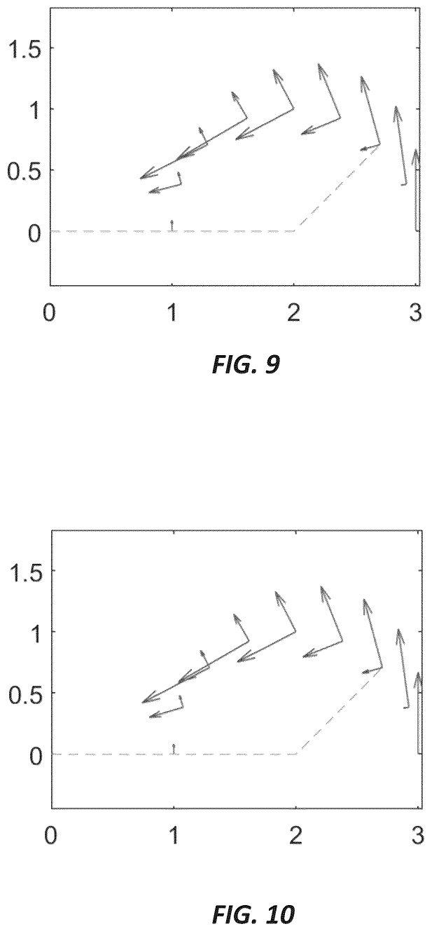

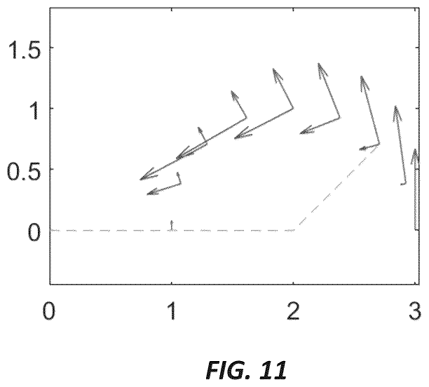

C=JK⁻¹J^{T} (6)
to produce a global compliance matrix C. The eigenvalues and eigenvectors of that matrix were then used to visualize the compliance ellipse for various combinations of stiffness values at the two joints, as shown in FIGS. 5-11. It should be noted that compliance ellipses are shown for varying angles of the second joint, but with a single reference position of the first joint, since rotation of the first joint would just produce a rotated set of the same compliance ellipses. Furthermore, for any pair of stiffness values with the same ratio k₁/k₂, the compliance ellipses display as identical, but their eigenvalues scale with the raw values of stiffness (therefore, results for k_{1,2}={kₘᵢₙ, kₘᵢₙ} and k_{1,2}={kₘₐₓ, kₘₐₓ} are not both shown here since their plots appear similar). Comparing and contrasting FIGS. 5-11 reveals certain properties of the variable-stiffness system. In positions where the two links are aligned (shown as (1,0) and (3,0)), the singularity of the manipulator causes the compliance ellipses to degenerate. However, at intermediate positions, the compliance ellipsoids can have a variety of orientations and aspect ratios, not to mention the varying stiffness magnitudes which are not directly visualized in these ellipse representations.

These results illustrate how a variable-stiffness link can produce behavior typical of a variable-stiffness joint which is easily modeled; they further show how adjusting individual stiffnesses in such a system can change the stiffness properties at the end effector.

A relatively simple and easy-to-implement variable-stiffness link that behaves like a variable-stiffness joint has been disclosed herein. When paired with a motor, it may act like a variable-stiffness actuator without the need to package the stiffness element(s) with the actuator itself. Testing of a prototype validated the mathematical model, showing a large range of stiffness variation based on a 2nd-order relationship between the input parameter and output stiffness at the joint. Simulation of a planar robot with this behavior integrated into its model illustrated the practical utility of such a design.

While the various systems described above are separate implementations, any of the individual components, mechanisms, or devices, and related features and functionality, within the various system embodiments described in detail above can be incorporated into any of the other system embodiments herein.

The terms “about” and “substantially,” as used herein, refers to variation that can occur (including in numerical quantity or structure), for example, through typical measuring techniques and equipment, with respect to any quantifiable variable, including, but not limited to, mass, volume, time, distance, wave length, frequency, voltage, current, and electromagnetic field. Further, there is certain inadvertent error and variation in the real world that is likely through differences in the manufacture, source, or precision of the components used to make the various components or carry out the methods and the like. The terms “about” and “substantially” also encompass these variations. The term “about” and “substantially” can include any variation of 5% or 10%, or any amount-including any integer-between 0% and 10%. Further, whether or not modified by the term “about” or “substantially,” the claims include equivalents to the quantities or amounts.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾ This applies regardless of the breadth of the range. Although the various embodiments have been described with reference to preferred implementations, persons skilled in the art will recognize that changes may be made in form and detail without departing from the spirit and scope thereof.

Although the various embodiments have been described with reference to preferred implementations, persons skilled in the art will recognize that changes may be made in form and detail without departing from the spirit and scope thereof.

What is claimed is:

1. A variable stiffness mechanism for robotic applications, the variable stiffness mechanism comprising:
(a) an outer link, the outer link comprising a proximal member and two elongate arms extending distally from the proximal member;
(b) an inner link having a proximal end and a distal end, the proximal end pivotably coupled to the proximal member of the outer link at a pivot joint, an elongate portion of the inner link operably suspended between the two elongate arms of the outer link;
(c) a spring disposed between the two elongate arms and in operable contact with the two elongate arms; and
(d) a carriage coupled to the spring and to the inner link, the carriage configured to move along a length of the inner link to change a position of the spring relative to the pivot joint.

2. The variable stiffness mechanism of claim 1, wherein changing the position of the spring relative to the pivot joint changes the stiffness of the variable stiffness mechanism.

3. The variable stiffness mechanism of claim 1, wherein the two elongate arms of the outer link at least partially surround the inner link.

4. The variable stiffness mechanism of claim 1 further comprising a motor configured to move the carriage along the length of the inner link.

5. The variable stiffness mechanism of claim 4 wherein the motor is configured to move the carriage along the length of the inner link via a belt drive.

6. The variable stiffness mechanism of claim 5 further comprising a stopper movably coupled to the inner link via the belt drive, the stopper configured to travel from a position distal of the two elongate arms to a position in contact with at least one of the two elongate arms.

7. The variable stiffness mechanism of claim 4 wherein the motor is configured to move the carriage along the length of the inner link via a lead screw.

8. A variable stiffness mechanism for robotic applications, the variable stiffness mechanism comprising:
(a) a first link, the first link comprising a proximal member and a first elongate arm extending distally from the proximal member;
(b) a second link, the second link comprising a second elongate arm having a proximal end and a distal end, the proximal end pivotably coupled to the proximal member of the first link at a pivot joint, the second elongate arm of the second link operably suspended adjacent the first elongate arm of the first link in a generally parallel configuration; and
(c) a spring disposed between the first elongate arm and the second elongate arm, the spring being in operable contact with the first elongate arm and the second elongate arm, the spring being configured to move along a length of the second link to change a distance of the spring from the pivot joint.

9. The variable stiffness mechanism of claim 8 further comprising:
(d) a carriage coupled to the spring and to the second link, the carriage configured to move the spring along the length of the second link.

10. The variable stiffness mechanism of claim 9 further comprising a motor configured to move the carriage along the length of the second link.

11. The variable stiffness mechanism of claim 10 wherein the motor is configured to move the carriage along the length of the second link via a belt drive.

12. The variable stiffness mechanism of claim 11 further comprising a stopper movably coupled to the second link via the belt drive, the stopper configured to travel from a position distal of the first elongate arm to a position in contact with the first elongate arm.

13. The variable stiffness mechanism of claim 10 wherein the motor moves the carriage along the length of the second link via a lead screw.

14. The variable stiffness mechanism of claim 13 wherein the second link includes a longitudinal track for guiding the carriage along the second link.

15. A variable stiffness mechanism for robotic applications, the variable stiffness mechanism comprising:
(a) a first link, the first link comprising a first elongate arm extending distally from a proximal end of the first link;
(b) a second link, the second link comprising a second elongate arm having a proximal end and a distal end, the proximal end pivotably coupled to the proximal end of the first link at a pivot joint, the second elongate arm of the second link operably suspended adjacent the first elongate arm of the first link in a generally parallel configuration; and
(c) a spring disposed between the first elongate arm and the second elongate arm, the spring being in operable contact with the first elongate arm and the second elongate arm, the spring being configured to move along a length of the second link to change a distance of the spring from the pivot joint.

16. The variable stiffness mechanism of claim 15 further comprising:
(d) a carriage coupled to the spring and to the second link, the carriage configured to move the spring along the length of the second link.

17. The variable stiffness mechanism of claim 16 further comprising a motor configured to move the carriage along the length of the second link.

18. The variable stiffness mechanism of claim 17 wherein the motor moves the carriage along the length of the second link via a belt drive.

19. The variable stiffness mechanism of claim 18 further comprising a stopper movably coupled to the second link via the belt drive, the stopper configured to travel from a position distal of the first elongate arm to a position in contact with the first elongate arm.

20. The variable stiffness mechanism of claim 17 wherein the motor moves the carriage along the length of the second link via a lead screw.
